(19) United States
(12) Patent Application Publication
(10) Pub. No.: US 2015/0225245 A1
(43) Pub. Date: Aug. 13, 2015

(54) METHOD FOR FORMING ACTIVATED CARBON

(71) Applicant: Corning Incorporated, Corning, NY (US)

(72) Inventors: Kishor Purushottam Gadkaree, Painted Post, NY (US); Atul Kumar, Horseheads, NY (US); Jia Liu, Painted Post, NY (US)

(73) Assignee: Corning Incorporated, Corning, NY (US)

(21) Appl. No.: 14/177,685

(22) Filed: Feb. 11, 2014

(51) Int. Cl. C01B 31/10; H01G 11/38

(52) U.S. Cl. CPC C01B 31/10; H01G 11/38; C01P 2004/61

(57) ABSTRACT

Carbon particles are exposed to an activating gas to form activated carbon. The morphology of the carbon particles is controlled prior to activation. Efficient activation can be achieved by minimizing the elongation and maximizing the circularity of the carbon particles.

### BACKGROUND

1. Field

The present disclosure relates generally to methods for forming activated carbon, and more specifically to physical activation methods for forming activated carbon having a high energy density. Also disclosed are high voltage EDLCs comprising carbon-based electrodes that include such activated carbon.

2. Technical Background

Energy storage devices such as ultracapacitors may be used in a variety of applications such as where a discrete power pulse is required. Example applications range from cell phones to hybrid vehicles. Ultracapacitors, also known as electric double layer capacitors (EDLCs), have emerged as an alternative or compliment to batteries in applications that require high power, long shelf life, and/or long cycle life. Ultracapacitors typically comprise a porous separator and an organic electrolyte sandwiched between a pair of carbon-based electrodes. The energy storage is achieved by separating and storing electrical charge in the electric double layers that are created at the interfaces between the electrodes and the electrolyte. Important characteristics of these devices are the energy density and power density that they can provide, which are both largely determined by the properties of the carbon that is incorporated into the electrodes.

Carbon-based electrodes suitable for incorporation into energy storage devices are known. Activated carbon is widely used as a porous material in ultracapacitors due to its large surface area, electronic conductivity, ionic capacitance, chemical stability, and/or low cost. Activated carbon can be made from synthetic precursor materials such as phenolic resins, or natural precursor materials such as coals and biomass. With both synthetic and natural precursors, the activated carbon can be formed by first carbonizing the precursor and then activating the intermediate product. The activation can comprise physical (e.g., steam) or chemical (e.g., KOH) activation at elevated temperatures to increase the porosity and hence the surface area of the carbon.

Both physical and chemical activation processes typically involve large thermal budgets to heat and react the carbonized material with the activating agent. In the case of chemical activation, corrosive by-products can be formed when a carbonized material is heated and reacted with an activating agent such as KOH. Additionally, phase changes that may occur during the heating and reacting of the carbonized material and chemical activating agent can result in undesired agglomeration of the mixture during processing. These drawbacks can add complexity and cost to the overall process, particularly for reactions that are carried out at elevated temperatures for extended periods of time.

Accordingly, it would be advantageous to provide activated carbon materials and processes for forming activated carbon materials using a more economical activation route while also minimizing the technical issues of corrosion and/or agglomeration. The resulting activated carbon materials can possess a high surface area to volume ratio and minimal reactivity, particularly with the organic electrolyte at elevated voltages, and can be used to form carbon-based electrodes that enable efficient, long-life and high energy density devices.

### BRIEF SUMMARY

In accordance with embodiments of the present disclosure, a method for fabricating activated carbon involves exposing carbon particles having a prescribed morphology to a gaseous activating agent such as steam or carbon dioxide. Efficient activation and a concomitant improvement in the capacitive performance of the resulting activated carbon can be affected by controlling the physical features of the carbon particles that are exposed to the activating gas.

In various embodiments, carbon particles are heated at an activation temperature while exposing the carbon particles to an activating gas to form activated carbon. The activation temperature can range from 300° C. to 1000° C., e.g., 300, 400, 500, 600, 700, 800, 900 or 1000° C., including ranges between any two of the foregoing values. The activating gas can include water vapor, carbon dioxide, oxygen, air, or mixtures thereof.

In various embodiments, the morphology of the particles is controlled such that generally spherical, non-elongated particles are activated. In one example method, a number-weighted elongation of the carbon particles exposed to the activating gas has a modal value of less than or equal to 0.15. In a further example method, a number-weighted high sensitivity circularity of the carbon particles exposed to the activating gas has a median value that is greater than or equal to 0.8. In related embodiments, a number-weighted high sensitivity circularity of at least 70% (e.g., at least 70, 80 or 90%) of the carbon particles exposed to the activating gas is greater than or equal to 0.8. In a still further example method, the carbon particles can have both a number-weighted elongation with a modal value of less than or equal to 0.15 and a number-weighted high sensitivity circularity median value of greater than or equal to 0.8.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic illustration of an example ultracapacitor;

FIG. 2 is plot showing elongation distribution for carbon materials according to embodiments;

FIG. 3 is a plot showing the high sensitivity circularity distribution for carbon material according to one embodiment;

FIG. 4 is a plot showing the high sensitivity circularity distribution for carbon material according to an embodiment;

FIG. 5 is a plot showing the high sensitivity circularity distribution for carbon material according to an embodiment; and

FIG. 6 is a plot showing the high sensitivity circularity distribution for carbon material according to an embodiment.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

According to various embodiments, a method of forming activated carbon comprises heating carbon particle feedstock at an activation temperature while exposing the carbon particles to an activating gas. Heating of the carbon particles and exposure to the activating gas can be carried out, for example, in a rotary kiln. In lieu of a rotary kiln, an alternate reaction chamber may comprise forming a fluidized dispersion of the carbon particles.

The carbon particle morphology is selected in order to promote efficient activation, which can enhance the properties of the resulting activated carbon while also increasing throughput and minimizing cost. In embodiments, a number-weighted elongation of the carbon particles has a modal value of less than or equal to 0.15. For example, a number-weighted elongation of the carbon particles can have a modal value of less than or equal to 0.15, 0.14, 0.12, 0.10, 0.08, 0.06, 0.04 or 0.02, including ranges between any of the foregoing. A number-weighted elongation of the carbon particles can have a modal value of 0. Alternatively, a number-weighted elongation of the carbon particles can have a modal value of greater than 0, i.e., 0<E≦0.15.

As defined herein, particle elongation, E, is equal to 1−(W/L), where W is particle width and L is particle length (W≦L) such that 0≦E<1 represents the possible values of E. Thus, both a circular particle and a square particle (W=L) have an elongation equal to 0. Elongation increases with particle acicularity. A rectangular particle having a length three times its width has an elongation equal to 0.67, while a rectangular particle having a length ten times its width has an elongation equal to 0.9.

In addition to, or in lieu of controlling the elongation of the carbon particles, in further embodiments, a number-weighted high sensitivity circularity of the carbon particles exposed to the activating gas has a median value greater than or equal to 0.8. For example, a median value of the high sensitivity circularity of the carbon particles exposed to the activating gas can be greater than or equal to 0.8, 0.85, 0.9 or 0.95, including ranges between any of the foregoing. In related embodiments, a number-weighted high sensitivity circularity of at least 70% (e.g., at least 70, 80 or 90%) of the carbon particles exposed to the activating gas is greater than or equal to 0.8. A number-weighted high sensitivity circularity of the carbon particles can have a median value of less than 1, e.g., 0.8≦Ψ<1. Thus, in embodiments a majority of the carbon particles can be substantially spherical, but not spherical. In further embodiments, the particles are substantially spherical, but spherical particles are excluded.

As defined herein, the high sensitivity circularity, Ψ, is equal to the square of the circularity, C (i.e., Ψ=C²), where the circularity C, which is a measure of the compactness of a particle, is equal to the ratio of the circumference of an equivalent-area circle to the actual circumference (perimeter) of a particle, C=P_{eq}/P, such that 0<C≦1 represents the possible values of C.

A circle has a circularity equal to 1, while a square has a circularity equal to about 0.89. The circularity of a rectangular particle having a length three times its width is equal to about 0.77, while a rectangular particle having a length ten times its width has a circularity equal to 0.51.

The elongation, circularity, and high sensitivity circularity for various particle shapes are summarized in Table 1.

TABLE 1
Quantified particle geometries

| | | | High Sensitivity |
|---|---|---|---|
| Shape | Elongation, E | Circularity, C | Circularity, Ψ |
| Circle | 0 | 1 | 1 |
| Oval (1.15:1) | 0.13 | 0.995 | 0.99 |
| Square | 0 | 0.89 | 0.79 |
| Rectangle (3:1) | 0.67 | 0.77 | 0.59 |
| Rectangle (10:1) | 0.9 | 0.51 | 0.26 |

It will be appreciated that the quantified shape of a carbon particle, i.e., elongation, circularity and high sensitivity circularity, is derived from a 2-dimensional projection of a 3-dimensional particle.

The morphology of the carbon particles prior to and following activation was characterized using a Morphologi G3 SE particle size and particle shape image analyzer. Samples were prepared using an evaporative technique with a volatile organic solvent and a low concentration of lecithin (approximately 0.01%). Samples were ultrasonicated in a low power sonication batch for 10 minutes prior to dispersing the preparations on a standard microscopic slide. A 50× objective lens was used. Details of the measurement procedure are summarized in Table 2.

An aspect of the image analysis is that each individual particle image is stored, making a number-based (as well as volume-based) analysis possible. Additionally, the storage of individual particle images allows for filtering of unwanted particles from the analysis. Typically, particle images comprising few than 100 pixels are removed using software filters. In a number-based counting technique, every particle has an equal weighting in the distribution. A cubic transformation enables the particle size distributions to be viewed by volume. In a volume-weighed distribution, a single 100 μm particle has the same contribution to the distribution as one thousand 10 μm particles. Thus, the contribution of small particles is more pronounced when considered on a number basis, while a volume-weighed distribution emphasizes large sized particles.

Discretized plots are generated from the scattergram obtained from Morphologi G3SE software. The scattergram is a density plot, so darker color represents more particles in a given region. The discretize setting utilized for this conversion was “intensity” with the lower limit set to 0 and the higher limit set to 75.

TABLE 2
Particle morphology measurement parameters

| | |
|---|---|
| Measurement Control | 1 plate |
| Sample Carrier | 4 slide plate |
| Compensation for tilt | Enabled |
| Optics selection (nominal | 50× (0.5-40 μm) |
| particle size range) | |
| Particle Stitching/Overlap | Unable/40% |
| Focus | Fixed |
| Threshold | 15, gray scale |
| Scan area | Circle, 2 mm radius |
| Trash size | 10 pixels |
| Analysis settings | Hole filling enabled, watershed |
| | disabled |
| Filters | Solidity < 0.900; Area (pixels) < |
| | 100 (Shape Assessment) |

Carbon particles may be synthesized from a variety of materials. According to embodiments, carbon particle feedstock may comprise a carbonized material such as coal or a carbonized material derived from a carbon precursor. Example carbon precursors include natural materials such as nut shells, wood, biomass, etc. and synthetic materials such as phenolic resins, including poly(vinyl alcohol) and (poly)acrylonitrile, etc. For instance, the carbon particle feedstock can be derived from edible grains such as wheat flour, walnut flour, corn flour, corn starch, corn meal, rice flour, and potato flour. Other carbon precursors include coconut husks, beets, millet, soybean, barley, and cotton. The carbon precursor can be derived from a crop or plant that may or may not be genetically-engineered.

Further example carbon precursor materials and associated methods of forming carbon feedstock material are disclosed in commonly-owned U.S. patent application Ser. Nos. 12/335,044, 12/335,078, 12/788,478 and 12/970,073, the entire contents of which are hereby incorporated by reference.

Carbon precursor materials can be carbonized to form carbon particle feedstock by heating in an inert or reducing atmosphere. Example inert or reducing gases and gas mixtures include one or more of hydrogen, nitrogen, ammonia, helium and argon. In an example process, a carbon precursor can be heated at a temperature from about 500° C. to 900° C. (e.g., 500, 550, 600, 650, 700, 750, 800, 850 or 900° C.) for a predetermined time (e.g., 0.5, 1, 2, 4, 8 or more hours) and then optionally cooled. During carbonization, the carbon precursor decomposes to form carbon particle feedstock. In embodiments, the carbonization may be performed using a conventional furnace or by heating with microwave energy.

Following carbonization, particles of the carbon feedstock may be processed by milling or grinding. For example, carbon feedstock may be milled to an average (D₅₀) particle size of less than 100 microns, e.g., less than 100, 50, 20 or 10 microns. In embodiments, the carbon feedstock can have an average particle size of about 2, 5, 10, 20, 50 or 100 microns. In further embodiments, the particle size of the carbon feedstock can range from 5 to 10 microns, 5 to 20 microns, 10 to 20 microns, 5 to 50 microns, 10 to 50 microns or 20 to 50 microns. In addition to the overall average particle size, the morphology of the carbon particles, including elongation and circularity, can be affected by milling and/or grinding.

The carbon material formed via carbonization can be activated by exposure to an activating gas. As used herein, activation refers to the process of heating carbonized or pyrolyzed material at an activation temperature during exposure to an activating gas-containing atmosphere to produce an activated carbon material. The activation process generally removes a given volume of surface material from the material being treated, resulting in an increased surface area. In various embodiments, the activation temperature can range from about 700° C. to 1100° C.

In one embodiment, the activation process can be done under a controlled atmosphere using a rotary kiln. A rotary kiln includes a cylindrical vessel, inclined slightly to the horizontal, which during operation is rotated about its axis. Carbon particle feedstock to be activated is fed into the upper end of the cylinder. As the kiln rotates, the carbon particles move down towards the lower end, and may undergo stirring and/or mixing. Activating gas(es) flow within the kiln, sometimes in the same direction as the motion of the carbon particles (co-current), but usually in the opposite direction (counter-current). Continuous motion of the carbon particle feedstock within the kiln enables efficient gas-solid interaction. The activating gases may be heated, for example in an external furnace, or may be heated by a flame inside the kiln. Such a flame is projected from a burner-pipe (or “firing pipe”) which acts like a large Bunsen burner.

As an alternative to a rotary kiln, the carbon particles may be activated in a fluidized bed as disclosed in commonly-owned and co-pending U.S. patent application Ser. No. 13/590,682, the contents of which are hereby incorporated by reference in their entirety.

The activated carbon can be washed, e.g., with an acidic solution. The washing can reduce the ash content and remove unwanted impurities. One process for washing the activated carbon involves sequentially rinsing the activated carbon with water and acid. A further washing process involves rinsing the activated carbon with an aqueous acid mixture (i.e., a mixture of acid and water). Acids used during the washing can include hydrochloric acid and sulfuric acid. The washing can be performed at a temperature of 90° C.-100° C.

In further embodiments, in addition to or in lieu of washing, the activated carbon can be heated treated in an inert or reducing atmosphere. The optional heat treatment can eliminate or lessen the concentration of oxygen in the activated carbon. For example, such a heat treatment can remove oxygen-containing functional groups from the activated carbon surface. One method to reduce oxygen content is to refine (heat) the activated carbon material in an inert environment (such as nitrogen, helium, argon, etc.) or in a reducing environment such as hydrogen, forming gas, carbon monoxide, etc.

Activated carbon refining can be performed in a retort furnace (CM Furnaces, Model 1212FL). The furnace temperature can be increased at a rate of 200° C./hr. to the desired refining heat treatment temperature (e.g., 500-900° C.), held constant for a suitable time (e.g., 2 hours), and then cooled down to room temperature before exposure to ambient atmosphere.

In embodiments, the activated carbon can be treated with both a washing step and a heat treatment, and where both processes are performed, the washing step may be performed either before or after the heat treatment.

The minimization of impurities and adsorbed surface groups in the activated carbon via washing and/or heat treatment can decrease the occurrence of unwanted reactions between such species and electrolyte ions during cell operation, particularly at elevated voltages. In some embodiments, the activated carbon includes a total oxygen content of less than 10 wt. %. In additional embodiments, the total oxygen content is less than 9, 8, 7, 6, 5, 4, 3, 2, 1 or 0.5 wt. %.

The activated carbon can comprise micro-, meso- and/or macroscale porosity. As defined herein, microscale pores have a pore size of 2 nm or less, and ultramicropores have a pore size of 1 nm or less. Mesoscale pores have a pore size ranging from 2 to 50 nm. Macroscale pores have a pore size greater than 50 nm. In an embodiment, the activated carbon comprises a majority of microscale pores. As used herein, the term “microporous carbon” and variants thereof means an activated carbon having a majority (i.e., at least 50%) of microscale pores. A microporous, activated carbon material can comprise greater than 50% microporosity (e.g., greater than 50, 55, 60, 65, 70, 75, 80, 85, 90 or 95% microporosity).

According to embodiments, a carbon-based electrode for an EDLC comprises activated carbon having a total porosity greater than about 0.2 cm³/g (e.g., greater than 0.2, 0.25, 0.3, 0.35, 0.4, 0.45, 0.5, 0.55, 0.6, 0.65, 0.7, 0.75, 0.8, 0.85 or 0.9 cm³/g). In related embodiments, the activation carbon can have a total porosity less than 1 cm³/g (e.g., less than 1, 0.9, 0.85, 0.8, 0.75, 0.7, 0.65, 0.6, or 0.55 cm³/g). In still further embodiments, the total porosity of the activated carbon can be between any of the foregoing values.

The pore size distribution of the activated carbon can include ultramicropores, micropores, mesopores and macropores and may be characterized as having a unimodal, bimodal or multi-modal pore size distribution. The ultramicropores can comprise 0.2 cm³/g or more (e.g., 0.2, 0.25, 0.3, 0.35 or 0.4 cm³/g or more) of the total pore volume and, in related embodiments, populations between any of the foregoing values, e.g., from 0.2 to 0.35 cm³/g or from 0.25 to 0.3 cm³/g. Pores having a pore size (d) in the range of 1<d≦2 nm can comprise 0.05 cm³/g or more (e.g., at least 0.05, 0.1, 0.15, 0.2, 0.25, 0.3, 0.35, 0.4, 0.45 or 0.5 cm³/g) of the total pore volume. Pores having a pore size (d) in the range of 1<d≦2 nm can comprise 0.55 cm³/g or less (e.g., less than 0.55, 0.5, 0.45, 0.4 or 0.35 cm³/g) of the total pore volume. In complimentary embodiments, the activated carbon can include pores having a pore size (d) in the range of 1<d≦2 nm between any of the foregoing values, e.g., from 0.05 to 0.25 cm³/g or from 0.1 to 0.2 cm³/g. If present, in an embodiment, any pores having a pore size greater than 2 nm, which may include mesopores and/or macropores, can comprise 0.25 cm³/g or less (e.g., less than 0.25, 0.2, 0.15, 0.1 or 0.05 cm³/g) of the total pore volume. In complimentary embodiments, the activated carbon can include pores having a pore size d>2 nm between any of the foregoing values, i.e., from 0.2 to 0.25 cm³/g or from 0.1 to 0.2 cm³/g. In still further embodiment, the activated carbon can be free of any pores having a pore size greater than 2 nm or free of any pores having a pore size greater than 5 nm.

The activated carbon made using the disclosed method can have a specific surface area greater than about 300 m²/g, i.e., greater than 350, 400, 500 or 1000 m²/g. In embodiments, the average particle size of the activated carbon can be milled to less than 20 microns (e.g., 2 to 10 microns or about 5 microns) prior to incorporating the activated carbon into a carbon-based electrode for an EDLC.

In a typical electric double layer capacitor (EDLC), a pair of carbon-based electrodes is separated by a porous separator and the electrode/separator/electrode stack is infiltrated with a liquid organic or inorganic electrolyte. The electrolytic solution allows ionic current to flow between the electrodes while preventing electronic current from discharging the cell. The electrodes comprise activated carbon that has been mixed with other additives (e.g., binders) and compacted into a thin sheet and laminated to a conductive metal current collector backing. For instance, the activated carbon can be mixed with carbon black and/or a polymeric binder such as polytetrafluroethylene (PTFE), polyvinylidene fluoride (PVDF) or other suitable binder and compacted to form the carbon-based electrodes.

By way of example, a carbon paper having a thickness in the range of about 100-300 micrometers can be prepared by rolling and pressing a mixture comprising 60-90 wt. % activated carbon particles, 5-20 wt. % carbon black and 5-20 wt. % PTFE. The carbon black serves as a conductive additive and the PTFE serves as a binder.

Each porous electrode is typically in electrical contact with a current collector. The current collector, which can comprise a sheet or plate of electrically-conductive material (e.g., aluminum) can reduce ohmic losses while providing physical support for the porous electrode (activated carbon) material. The carbon-based electrodes can be rolled into a jelly roll configuration using a cellulosic separator, and then placed into an aluminum enclosing body.

Thus, the present disclosure also relates to an electrical device, such as an electric double layer capacitor, comprising at least one carbon-based electrode that includes the activated carbon material described herein.

By way of example, a carbon electrode layer was prepared by mixing, by weight, 85% activated carbon, 5% carbon black, and 10% PTFE binder (DuPont 601A). The mixture was initially combined using a Henschel high speed mixer and then the PTFE was fibrillated using a ball mill, jet mill or twin screw extruder. The fibrillated mixture of activated carbon, carbon black and PTFE was calendared to form a carbon paper. The typical sheet thickness was about 100 microns. Carbon-based electrodes were made by laminating the activated carbon-containing sheets (approx. 1.5 cm×2 cm) onto a 25 micron thick aluminum foil current collector. After drying the carbon-based electrodes overnight at 120° C. in a vacuum over, test cells were assembled in a glove box filled with dry argon gas. The test cells were made by sandwiching a piece of cellulose separator between two carbon-based electrodes. The carbon-based electrodes, together with a cellulose separator, were wound into a jelly roll. The jelly roll was inserted into an aluminum enclosing body and vacuum dried (130° C. for 48 hours at <0.05 Torr). Liquid electrolyte (1.2 M TEMA-TFB in acetonitrile) was added to the enclosing body.

According to embodiments, an electrochemical cell includes at least a first electrode comprising an activated carbon material as disclosed herein, a porous separator, and a pair of electrically conductive substrates, wherein the porous separator is disposed between the first electrode and a second electrode, and the first and second electrodes are each in electrical contact with a respective electrically conductive substrate. According to further embodiments, an electrochemical cell includes first and second electrodes each comprising an activated carbon material as disclosed herein.

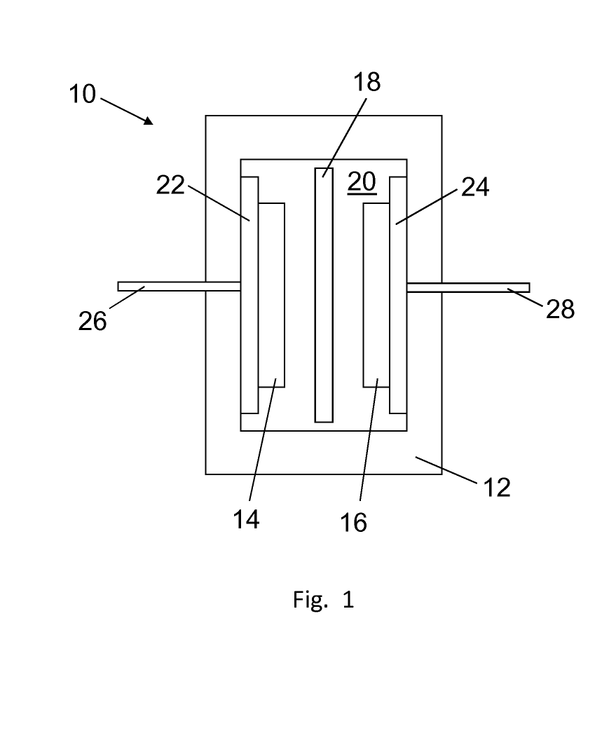

FIG. 1 is a schematic illustration of an example ultracapacitor. Ultracapacitor 10 includes an enclosing body 12, a pair of current collectors 22, 24, a positive electrode 14 and a negative electrode 16 each respectively formed over one of the current collectors, and a porous separator layer 18. Electrical leads 26, 28 can be connected to respective current collectors 22, 24 to provide electrical contact to an external device. Electrodes 14, 16 comprise porous activated carbon layers that are formed over the current collectors. A liquid electrolyte 20 is contained within the enclosing body and incorporated throughout the porosity of both the porous separator layer and each of the porous electrodes. In embodiments, individual ultracapacitor cells can be stacked (e.g., in series) to increase the overall operating voltage.

The enclosing body 12 can be any known enclosure means commonly-used with ultracapacitors. The current collectors 22, 24 generally comprise an electrically-conductive material such as a metal, and commonly are made of aluminum due to its electrical conductivity and relative cost. For example, current collectors 22, 24 may be thin sheets of aluminum foil.

Porous separator 18 electronically insulates the carbon-based electrodes 14, 16 from each other while allowing ion diffusion. The porous separator can be made of a dielectric material such as cellulosic materials, glass, and inorganic or organic polymers such as polypropylene, polyesters or polyolefins. In embodiments, a thickness of the separator layer can range from about 10 to 250 microns.

The electrolyte 20 serves as a promoter of ion conductivity, as a source of ions, and may serve as a binder for the carbon. The electrolyte typically comprises a salt dissolved in a suitable solvent. Suitable electrolyte salts include quaternary ammonium salts such as those disclosed in commonly-owned U.S. patent application Ser. No. 13/682,211, the disclosure of which is incorporated herein by reference. Example quaternary ammonium salts include tetraethylammonium tetraflouroborate ((Et)₄NBF₄) or triethylmethyl ammonium tetraflouroborate (Me(Et)₃NBF₄).

Example solvents for the electrolyte include but are not limited to nitriles such as acetonitrile, acrylonitrile and propionitrile; sulfoxides such as dimethyl, diethyl, ethyl methyl and benzylmethyl sulfoxide; amides such as dimethyl formamide and pyrrolidones such as N-methylpyrrolidone. In embodiments, the electrolyte includes a polar aprotic organic solvent such as a cyclic ester, chain carbonate, cyclic carbonate, chain ether and/or cyclic ether solvent. Example cyclic esters and chain carbonates have from 3 to 8 carbon atoms, and in the case of the cyclic esters include β-butyro-lactone, γ-butyrolactone, γ-valerolactone and δ-valerolactone. Examples of the chain carbonates include dimethyl carbonate, diethyl carbonate, dipropyl carbonate, ethylene carbonate, methyl ethyl carbonate, methyl propyl carbonate and ethyl propyl carbonate. Cyclic carbonates can have from 5 to 8 carbon atoms, and examples include 1,2-butylene carbonate, 2,3-butylene carbonate, 1,2-pentene carbonate, 2,3-pentene carbonate and propylene carbonate. Chain ethers can have 4 to 8 carbon atoms. Example chain ethers include dimethoxyethane, diethoxyethane, methoxyethoxyethane, dibutoxyethane, dimethoxypropane, diethoxypropane and methoxyethoxypropnane. Cyclic ethers can have from 3 to 8 carbon atoms. Example cyclic ethers include tetrahydofuran, 2-methyl-tetrahydrofuran, 1,3-dioxolan, 1,2-dioxolan, 2-methyldioxolan and 4-methyldioxolan. A combination of two or more solvents may also be used.

As examples, an assembled EDLC can comprise an organic liquid electrolyte such as tetraethylammonium tetrafluoroborate (TEA-TFB) or triethylmethylammonium tetrafluoroborate (TEMA-TFB) dissolved in an aprotic solvent such as acetonitrile.

Ultracapacitors may have a jelly roll design, prismatic design, honeycomb design, or other suitable configuration. A carbon-based electrode made according to the present disclosure can be incorporated into a carbon-carbon ultracapacitor or into a hybrid ultracapacitor. In a carbon-carbon ultracapacitor, both of the electrodes are carbon-based electrodes. In a hybrid ultracapacitor, one of the electrodes is carbon-based, and the other electrode can be a pseudo capacitive material such as lead oxide, ruthenium oxide, nickel hydroxide, or another material such as a conductive polymer (e.g., parafluorophenyl-thiophene).

In carbon-carbon ultracapacitors, the activated carbon in each electrode may have the same, similar or distinct properties. For example, the pore size distribution or particle morphology of the activated carbon incorporated into a positive electrode may be different than the pore size distribution or particle morphology of the activated carbon incorporated into a negative electrode.

Within an individual ultracapacitor cell, and under the influence of an applied electric potential, an ionic current flows due to the attraction of anions in the electrolyte to the positive electrode and cations to the negative electrode. Ionic charge can accumulate at each of the electrode surfaces to create charge layers at the solid-liquid interfaces. The accumulated charge is held at the respective interfaces by opposite charges in the solid electrode to generate an electrode potential.

During discharge of the cell, a potential across the electrodes causes ionic current to flow as anions are discharged from the surface of the positive electrode and cations are discharged from the surface of the negative electrode. Simultaneously, an electronic current can flow through an external circuit located between the current collectors. The external circuit can be used to power electrical devices.

The amount of charge stored in the layers impacts the achievable energy density and power density of the capacitor. The performance (energy and power density) of an ultracapacitor depends largely on the properties of the activated carbon that makes up the electrodes. The properties of the activated carbon, in turn, can be gauged by evaluating, for example, the porosity and pore size distribution of the activated carbon, as well as the impurity content within the activated carbon, such as nitrogen or oxygen. Relevant electrical properties include the potential window, area-specific resistance and the volumetric capacitance.

When incorporated into an ultracapacitor, the activated carbon according to the present disclosure may, in some embodiments, exhibit operating voltages up to 3.2 V (e.g., 2.7, 2.8, 2.9, 3.0, 3.1 or 3.2 V) and a volumetric capacitance of greater than 50 F/cm³ (e.g., greater than 50, 60, 70, or 80 F/cm³), including capacitance values between any of the foregoing values. Without wishing to be bound by theory, the high potential window is believed to be the result of the low reactivity of the activated carbon, which may be attributable to a low concentration of oxygen-containing functional groups within the material.

### EXAMPLES

Various embodiments will be further clarified by the following examples.

### Example 1

### Coconut Char; D₅₀=5 μm, E=0.13, and 0.84<Ψ<1

Coconut char (2-3 mm particle size) was vibratory milled to a D₅₀ particle size of about 5 microns. After milling, the number-weighted circle-equivalent particle diameter is characterized by D [n,0.1]=0.5 μm, D [n,0.5]=1.1 μm, and D [n,0.9]=2.5 μm. The corresponding volume-weighted circle-equivalent diameter is characterized by D [v,0.1]=2.0 μm, D [v,0.5]=6.8 μm, and D [v,0.9]=14.9 μm.

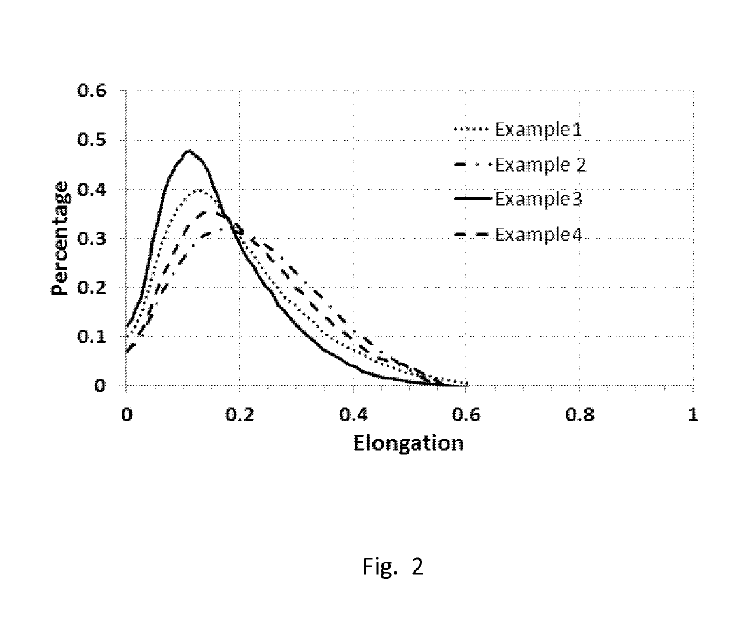

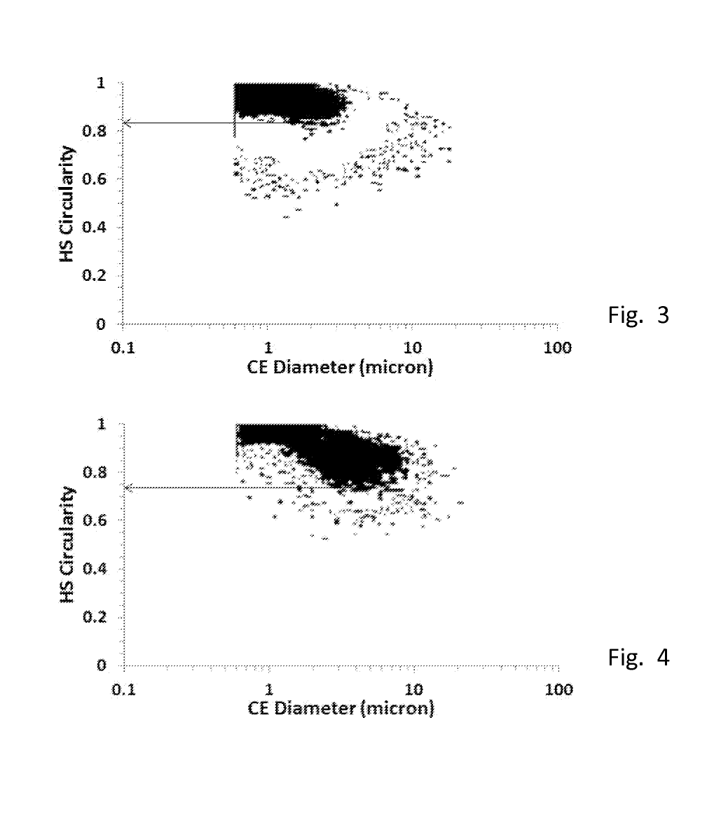

As shown in FIG. 2, the number-weighed elongation of the ground char particles has a modal value of around 0.13 and a HS circularity where at least 70% of the particles are within the range of 0.84 to 1. A scatter plot of the HS circularity versus particle size is shown in FIG. 3.

### Example 2

### Coconut Char; D₅₀=5 μm; E=0.17; and 0.74<Ψ<1

Coconut char (2-3 mm particle size) was ground using a fluidized jet mill to a D₅₀ particle size of about 5 microns. The number-weighted circle-equivalent diameter of the particles after milling is characterized by D [n,0.1]=0.9 μm, D [n,0.5]=2.3 μm, and D [n,0.9]=5.0 μm. The corresponding volume-weighted circle-equivalent diameter is characterized by D [v,0.1]=3.1 μm, D [v,0.5]=7.1 μm, and D [v,0.9]=12.0 μm.

The number-weighed elongation of the ground char particles has a modal value of around 0.17 (FIG. 2) and a HS circularity where at least 70% of the particles are within the range of 0.74 to 1. A scatter plot of the HS circularity versus particle size is shown in FIG. 4.

The example 2 jet milled carbon particles, which are comparative, can be contrasted with the vibratory-milled particles of example 1. Notably, the example 1 particles are more spherical (lower elongation value, and a circularity closer to 1). The degree of circularity is evident from the concentration of particles in the respective scatter plots. Without wishing to be bound by theory, it is believed that the more spherical particles have fewer stress concentration regions (sharp corners, edges, etc.), which may adversely affect the activation process.

The milled carbon particles from examples 1 and 2 (20 g samples) were activated in a rotary kiln (1.5 rpm) using a CO₂-based process (1 liter/min) at 850° C. for 4.25 hr. Capacitive performance was evaluated by incorporating the activated carbon into button cells.

### Example 3

### CO₂-Activated Coconut Char from Example 1

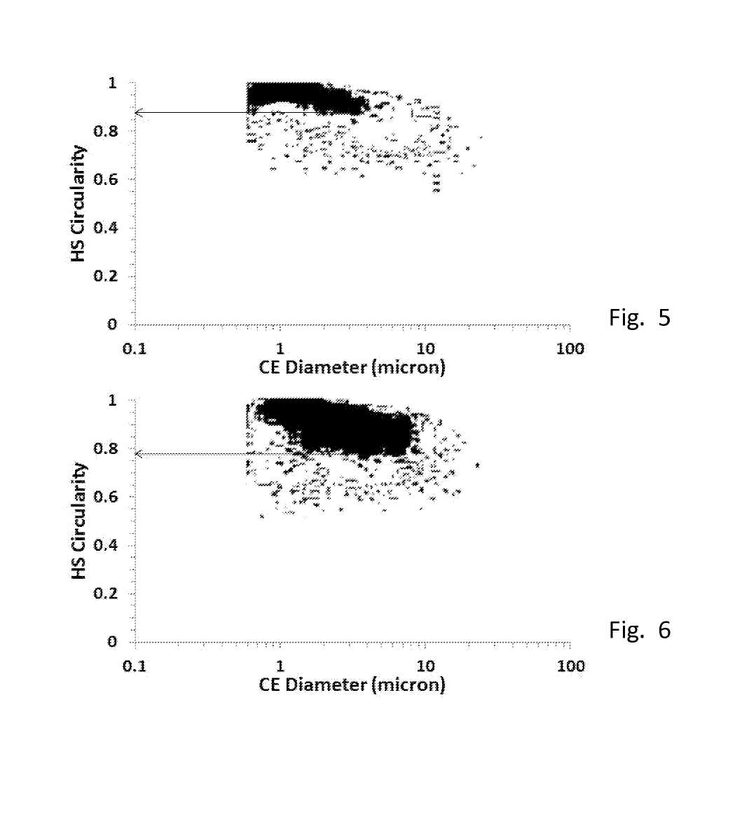

Following activation, the number-weighted circle-equivalent diameter for the carbon particles is characterized by D [n,0.1]=0.5 μm, D [n,0.5]=1.2 μm, D [n,0.9]=3.1 μm. The corresponding volume-weighted circle equivalent (CE) diameter is characterized by D [v,0.1]=3.3 μm, D [v,0.5]=9.4 μm, D [v,0.9]=17.0 μm. The number-weighed elongation of the activated particles has a modal value of around 0.11 (FIG. 2) and a HS circularity where at least 70% of the particles are in the range of 0.88 to 1. A scatter plot of the HS circularity versus particle size is shown in FIG. 5.

Evident from the particle analyzer data is the effect of activation on the morphology of the carbon particles. Stress concentration regions are largely burned-off during the activation process leading to more circular (spherical) particles. As seen with reference to the data, the rotary kiln activation process reduces the elongation and increases the circularity of the particles.

When incorporated into a button cell with 1.5M TEA-TFB electrolyte dissolved in acetonitrile, the activated carbon displayed a volumetric capacitance of 80 F/cc.

### Example 4

### Comparative CO₂-Activated Coconut Char from Example 2

The number-weighted circle-equivalent diameter for the activated particles is characterized by D [n,0.1]=1.1 μm, D [n,0.5]=2.4 μm, D [n,0.9]=5.1 μm. The corresponding volume-weighted circle equivalent (CE) diameter is characterized by D [v,0.1]=3.1 μm, D [v,0.5]=7.1 μm, D [v,0.9]=12.4 μm. The number-weighed elongation of the activated particles has a modal value of around 0.15 (FIG. 2) and a HS circularity where at least 70% of the particles are in the range of 0.78 to 1. A scatter plot of the HS circularity versus particle size is shown in FIG. 6.

When incorporated into a button cell with 1.5M TEA-TFB electrolyte dissolved in acetonitrile, the activated carbon displayed a volumetric capacitance of 69.5 F/cc.

The effect of particle morphology on activation can be seen with reference to the performance data in examples 3 and 4. A 16% improvement in the volumetric capacitance can be associated with pre-activation differences in feedstock particle morphology.

TABLE 3
Statistical parameters of the CE diameter distribution for Examples 1-4

| Sample | # of | D [n,0.1] | D [n,0.5] | D [n,0.9] | D [v,0.1] | D [v,0.5] | D [v,0.9] |
|---|---|---|---|---|---|---|---|
| 50X | Particles | (μm) | (μm) | (μm) | (μm) | (μm) | (μm) |
| Example 1 | 51,802 | 0.5 | 1.1 | 2.5 | 2.0 | 6.8 | 14.9 |
| Example 2 | 26,617 | 0.9 | 2.3 | 5.0 | 3.1 | 7.1 | 12.0 |
| Example 3 | 21,482 | 0.5 | 1.2 | 3.1 | 3.3 | 9.4 | 17.0 |
| Example 4 | 33,670 | 1.1 | 2.4 | 5.1 | 3.1 | 7.1 | 12.4 |

TABLE 4
Elongation and HS circularity data for Examples 1-4

| | Elongation, Range | HS Circularity |
|---|---|---|
| Sample | [modal value] | Threshold Range |
| Example 1 | 0-0.6 [0.13] | 0.84-1.0 |
| Example 2 | 0-0.6 [0.17] | 0.74-1.0 |
| Example 3 | 0-0.6 [0.11] | 0.88-1.0 |
| Example 4 | 0-0.6 [0.15] | 0.78-1.0 |

As seen with reference to the examples, milled carbon particles with lower elongation (0≦E≦0.15) and higher circularity values (0.8≦Ψ≦1) (e.g., example 1) lead to more uniform activation and a concomitant higher capacitance in an EDLC device. This is believed to be due to a relative absence of stress-concentration zones in particles that are generally more spherical. Further, it can be seen that the activation process itself tends to reduce the elongation and increase the circularity of the carbon particles. This is believed to be due to a burn-off of sharp edges during the activation process.

As used herein, the singular forms “a,” “an” and “the” include plural referents unless the context clearly dictates otherwise. Thus, for example, reference to an “activated carbon” includes examples having two or more such “activated carbons” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon-based electrode comprising activated carbon, carbon black and a binder include embodiments where a carbon-based electrode consists of activated carbon, carbon black and a binder and embodiments where a carbon-based electrode consists essentially of activated carbon, carbon black and a binder.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A method of forming activated carbon, comprising:
heating carbon particles at an activation temperature while exposing the carbon particles to an activating gas to form activated carbon, wherein a number-weighted elongation of the carbon particles has a modal value of less than or equal to 0.15.

2. The method according to claim 1, wherein the elongation modal value is less than or equal to 0.10.

3. The method according to claim 1, wherein the elongation modal value is greater than 0.

4. The method according to claim 1, wherein a number-weighted high sensitivity circularity of the carbon particles has a median value of greater than or equal to 0.8.

5. The method according to claim 1, wherein a number-weighted high sensitivity circularity of the carbon particles has a median value of greater than or equal to 0.9.

6. The method according to claim 1, wherein a number-weighted high sensitivity circularity of at least 70% of the carbon particles is greater than or equal to 0.8.

7. The method according to claim 1, wherein a number-weighted high sensitivity circularity of the carbon particles has a median value of less than 1.

8. The method according to claim 1, wherein the carbon particles have a D₅₀ particle size of less than 100 microns.

9. The method according to claim 1, wherein the carbon particles have a D₅₀ particle size of less than 10 microns.

10. The method according to claim 1, wherein the exposing is performed in a rotary kiln.

11. The method according to claim 1, wherein the activation temperature is from 300-1000° C.

12. The method according to claim 1, wherein the activation temperature is from 600-1000° C.

13. The method according to claim 1, wherein the activating gas is selected from the group consisting of carbon dioxide, water vapor, oxygen, air, and mixtures thereof.

14. The method according to claim 1, wherein the activating gas is carbon dioxide.

15. The activated carbon produced according to the method of claim 1.

16. A method of forming activated carbon, comprising:
heating carbon particles at an activation temperature while exposing the carbon particles to an activating gas to form activated carbon, wherein a number-weighted high sensitivity circularity of the carbon particles has a median value of greater than or equal to 0.8.

17. The method according to claim 16, wherein a number-weighted high sensitivity circularity of at least 70% of the carbon particles is greater than or equal to 0.8.

18. The method according to claim 16, wherein the high sensitivity circularity median value is less than 1.

19. The method according to claim 16, wherein the carbon particles have a D₅₀ particle size of less than 10 microns.

20. The method according to claim 16, wherein the exposing is performed in a rotary kiln.

21. The method according to claim 16, wherein the activating gas is carbon dioxide.

22. A carbon-based electrode comprising particles of activated carbon, carbon black and a binder, wherein a number-weighted elongation of the carbon particles has a modal value of less than or equal to 0.15.
